(19) United States
(12) Patent Application Publication
(10) Pub. No.: US 2023/0419397 A1
(43) Pub. Date: Dec. 28, 2023

(54) COMPUTER SYSTEM FOR AUTOMATED DECISION-MAKING ON BEHALF OF UNAVAILABLE USERS

(71) Applicant: Wells Fargo Bank, N.A., San Francisco, CA (US)

(72) Inventors: Kristine Ing Kushner, Orinda, CA (US); John T. Wright, Benicia, CA (US)

(21) Appl. No.: 16/912,499

(22) Filed: Jun. 25, 2020

(51) Int. Cl. G06Q 40/02; G06Q 20/40; G06Q 30/02; G06Q 10/10; G06Q 30/00; G06Q 50/18; G06Q 50/00; G06N 20/00; G06N 5/04; G06K 9/00; G06K 9/62

(52) U.S. Cl. CPC G06Q 40/02; G06Q 20/405; G06Q 30/0201; G06Q 10/1097; G06Q 30/0185; G06Q 50/186; G06Q 50/01; G06N 20/00; G06N 5/04; G06K 9/00335; G06K 9/6256; G06K 9/6253

(57) ABSTRACT

A computer system is described that is configured to make automated decisions to perform financial affair management on behalf of a user who is unable or unwilling to manage their financial affairs. The computer system accepts user-defined rules regarding how to manage the financial affairs of the user and, in some cases, when to assume control of the user's financial accounts. The computer system also generates computer-learned rules based on historical financial behavior patterns of the user. In certain scenarios, the computer system assumes control of the user's financial accounts and continues management and decision making responsibilities on the user's behalf based on the user-defined rules and the computer-learned rules. The computer system may assume control temporarily for an unavailable user or assume control indefinitely for an incompetent user. The computer system may alert the user prior to assuming control of the financial accounts.

### TECHNICAL FIELD

The present disclosure relates to computer systems, and, in particular, using computer systems for automated decision-making.

### BACKGROUND

Financial institutions, such as commercial and investment banks, may assist with management of financial affairs for their clients. For example, a particular client may primarily manage their financial affairs through the use of bank accounts, brokerage accounts, and other accounts that are held at the financial institution. In some cases, the particular client may request assistance with the management of their financial affairs from wealth management or other financial advisors associated with the financial institution. The particular client's financial affairs may include all of their assets (e.g., liquid assets, retirement assets, stocks and other long-term investments, business holdings, real estate holdings, and the like) as well as all of their liabilities (e.g., recurring bills, short- and long-term debt, and the like).

When a client becomes incapable of making competent decisions regarding their financial affairs (e.g., as a result of age or medical issues), normally another person is designated to make financial and other decisions for that person. However, providing another person with such power comes with some risk of abuse and/or fraud.

### SUMMARY

In general, this disclosure describes a computer system configured to make automated decisions to perform financial affair management on behalf of a user who is unable or unwilling to manage their financial affairs personally. Initially, the user may manage their own financial affairs by requesting certain financial transactions from one or more financial accounts in response to financial events (e.g., paying a received bill, contesting an unfamiliar charge, transferring money to an account with a low balance, etc.). The user may also predefine how the computer system described herein should respond to certain financial events. For example, the computer system may accept user-defined rules regarding how to manage the financial affairs of the user and, in some cases, when to assume control of the user's financial accounts. In addition, the computing system may generate computer-learned rules based on historical financial behavior patterns of the user and/or historical financial behavior patterns of a population of users belonging to a substantially similar demographic as the user.

The computer system described herein may, with the user's permission, assume control of the user's financial accounts and continue the management and decision making responsibilities on the user's behalf based on the user-defined rules and the computer-learned rules. The user may have a preplanned absence, such as travel abroad or a surgery with a long recovery period, or the user may show new signs of incompetence, such as dementia or other cognitive decline. The computer system may assume control temporarily during the preplanned absence as directed by the user (e.g., during the scheduled travel or surgery), or the computer system may assume control indefinitely based on one or more anomalous transactions requested by the user as an indicator of incompetence. The computer system may alert the user prior to assuming control of the financial accounts such that the user may have the opportunity to override the computer system's decision.

As one example, this disclosure is directed to a method comprising monitoring, by a computer system, financial behavior of a user in one or more financial accounts; determining, by the computer system, a status change of the user in response to one of a status change indication received from a user device of the user or the monitored financial behavior of the user; in response to the status change of the user, assuming, by the computer system, control of the one or more financial accounts; and upon assuming control of the one or more financial accounts, executing, by the computer system, one or more financial transactions on behalf of the user in accordance with user-defined rules and computer-learned rules based at least on historical financial behavior patterns of the user.

As another example, this disclosure is directed to a computer system comprising one or more memory units, and one or more processors in communication with the memory units. The one or more processors are configured to monitor financial behavior of a user in one or more financial accounts; determine a status change of the user in response to one of a status change indication received from a user device of the user or the monitored financial behavior of the user; in response to the status change of the user, assume control of the one or more financial accounts; and upon assuming control of the one or more financial accounts, execute one or more financial transactions on behalf of the user in accordance with user-defined rules and computer-learned rules based at least on historical financial behavior patterns of the user.

As a further example, this disclosure is directed to a computer-readable medium storing instructions that, when executed, cause one or more processors to monitor financial behavior of a user in one or more financial accounts; determine a status change of the user in response to one of a status change indication received from a user device of the user or the monitored financial behavior of the user; in response to the status change of the user, assuming control of the one or more financial accounts; and upon assuming control of the user's financial accounts, execute one or more financial transactions on behalf of the user in accordance with user-defined rules and computer-learned rules based at least on historical financial behavior patterns of the user.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example computer system including an account management system for automated decision-making, in accordance with the disclosure.

FIG. 2 is a block diagram illustrating an example of the account management system of FIG. 1, in further detail.

FIG. 3 is a flow diagram illustrating an example operation of a computer system assuming control and managing financial accounts on behalf of a user, in accordance with the disclosure.

### DETAILED DESCRIPTION

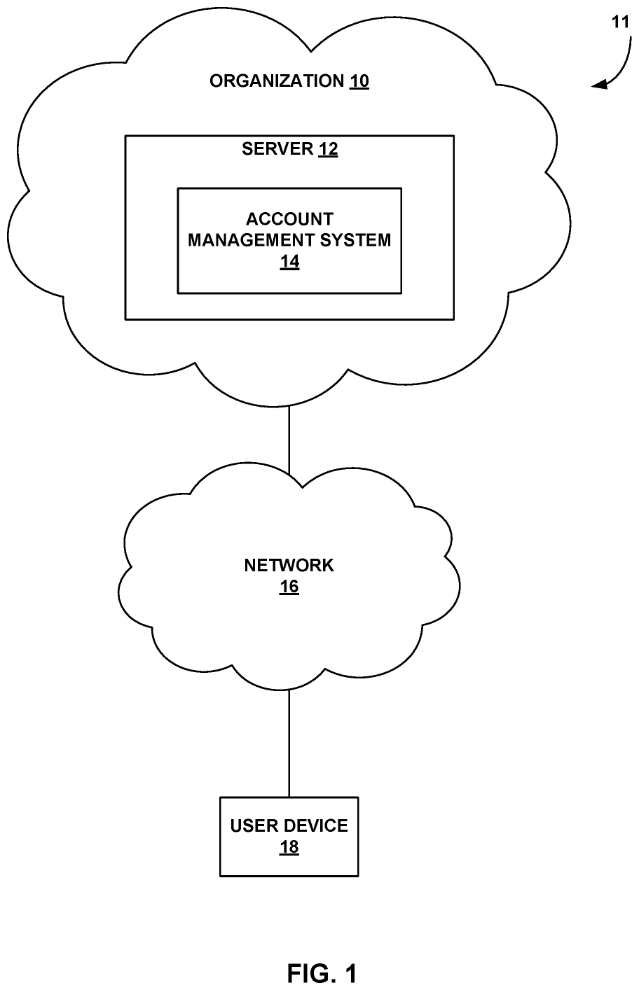

FIG. 1 is a block diagram illustrating example computer system 11, including account management system 14, for automated decision-making, in accordance with the disclosure.

As shown in the example of FIG. 1, account management system 14 on server 12 of organization 10 may communicate with a user through user device 18 via network 16. Network 16 may comprise a private network, such as associated with organization 10, or may comprise a public network, such as the Internet. Although illustrated as a single entity, network 16 may comprise a combination of networks. In some examples, network 16 may comprise one or more of a wide area network (WAN), a local area network (LAN), a virtual private network (VPN), an enterprise network, or another wired or wireless communication network. User device 18 may be any user device with which a user can manage an account (e.g., a laptop, a smartphone, a tablet, etc.). Although account management system 14 is shown as a single system, it may comprise several systems and units. Although the following description will primarily refer to a corporation using account management system 14, it should be understood that, in other examples, a different entity may use, own, and/or operate account management system 14.

Organization 10 may be a traditional bank with the capacity to issue an account to a user. For example, organization 10 may receive a deposit into an account from a user and enable withdrawals, check-writing, and bill payments from the account by the user. Organization 10 may invest the deposit and pay interest on the investment. Organization 10 may enforce regulations on the account, such as subjecting an account to an overdraft fee in the event of a withdrawal exceeding an account balance, or requiring that the account balance maintain a minimum above zero. Organization 10 may provide lines of credit (e.g., on purchases via credit cards, cars, homes, etc.) with additional regulations, such as repayment due dates, interest charges on nonzero balances, or credit limits. Thus, the account may require ongoing management of financial activities to maintain order in the user's financial affairs while the user's bills and other expenses are paid.

While referred to herein as “an account,” the user's account may consist of several interconnected accounts, including one or more checking accounts, savings accounts, credit card accounts, trading accounts, cryptocurrency wallets, etc. Hereafter, an “account” may mean one or more accounts held by the user.

In some examples, the user may have a deposit account with organization 10 as well as one or more credit cards, each with a respective credit limit, and/or a loan (e.g., a mortgage, a car loan, student loans, etc.) with a monthly payment. The user may make sporadic purchases of irregular amounts on a credit card and may pay off the credit card, for example, once per month. The user may pay bills from the account, including some bills automatically deducted from the account on a periodic basis (e.g., through online bill pay). The user may be subject to an overdraft fee in case of overdrawing the account. The user may periodically request a credit score report and compare the credit score to a preferred score. Effective management of the account may depend on a variety of factors, including the user's priorities and boundaries as well as a source of a bill, the amount of a bill, and/or the ability to pay a bill. In addition, account regulations and an effective method for responding to events in the account may change over time. For example, the effective method for responding to events in the account may change based on new medical concerns, diverse travel plans, a new home, etc.

The user may be frequently engaged in managing the account. In some examples, the user may expect to be unable or unwilling to maintain the frequency of engagement to manage the account effectively. For example, the user may be travelling abroad without consistent access to the account. Alternatively, the user may be anticipating a week of infirmity after a scheduled surgery. In another example, the user may be expecting an onset of dementia at an undetermined time due to an illness like Alzheimer's Disease. During such times of inability to manage the account, the user may want to ensure ongoing administration of the account, including, for example, maintaining a positive account balance, avoiding overdraft fees, confirming the legitimacy of money requests, paying bills, etc.

The user may want to delegate the account management to a third party with minimal communication on how to manage the account effectively. The user may entrust the account to a third party, such as a family member, a friend, or a finance professional. The user may communicate some preferences to the third party regarding account management. Then, in the absence or incompetence of the user, the third party may manage the account according to the communicated preferences. However, the third party may lack insight on the user's preferences for an unforeseen situation and be forced to guess at the user's preferences. Alternatively, the third party may ignore the user's preferences and abuse access to the account, such as by stealing money from the user. Third-party management may also be prone to error due to negligence (e.g., the third party may forget to pay a bill), inaccuracy (e.g., the third party may misread a number), or unfamiliarity (e.g., the third party may not know that a bill was too high).

Additionally, or alternatively, some third-party account management systems may be computer-based. However, such computer-based account management systems may only respond to events following a specific request from the user. Such computer-based systems may respond to events in an ad hoc manner. For example, the computer-based systems may not differentiate familiar and unfamiliar bill sources or consider the context of an account (e.g., a low account balance) before responding to a bill. In another example, the computer-based systems may not recognize anomalous behavior by the user that suggests an inability to manage the account. In turn, the computer-based systems may be inefficient and inaccurate.

Account management system 14 of computer system 11 is configured to monitor financial behavior of a user of an account, determine a status change of the user from user device 18 or from anomalies in the financial behavior, assume control of the account in response to the status change, and execute financial transactions on behalf of the user. Account management system 14 may use a system of rules and models to make decisions representative of the user's behavior.

Account management 14 may be more accurate, more efficient, and more trustworthy in comparison to some other account management systems. For example, account management 14 may more quickly and accurately intervene on a user's behalf by recognizing when a user needs third-party management and determine to execute decisions similar to actions previously made by the user.

The functionality of account management system 14 may be implemented in hardware or in a combination of software and hardware, where requisite hardware may be provided to store and execute software instructions. While shown as a single computing device in FIG. 1 for purposes of illustration, in some examples, account management system 14 may be executed on a distributed network of computing devices including one or more workstations, servers, and/or other computing devices. In some examples, account management system 14 may comprise an application, program, or other software provided by organization 10 to manage a user's account.

Account management system 14 may be in a learning stage, a supervising stage, or an execution stage. In the learning stage, account management system 14 determines historical financial behavior patterns based on the user's historical financial data with respect to the account. In the supervising stage, account management system 14 compares the historical financial behavior patterns to the user's current financial activity in real-time as a method of determining when account management system 14 should assume management responsibilities of the account. In the execution stage, account management system 14 assumes management of the account to automatically execute financial transactions from the account in accordance with user-defined rules and computer-learned rules based at least on the historical financial behavior patterns of the user.

In the learning stage, account management system 14 determines the historical financial behavior patterns of the user based on historical financial data of the user. Account management system 14 applies the user's historical financial data to develop one or more models representing the historical financial behavior patterns of the user. Account management system 14 may use the one or more models to predict a user's actions in response to a new financial event. During the learning stage, account management system 14 may then compare the predicted actions with the user's actual actions and refine the one or more models to accommodate any differences.

Account management system 14 may observe the user's actions while the user interacts with the account over network 16 via user device 18. In addition, account management system 14 may access records of the user's historical financial data for the account including a transaction history and account context over time. Transaction history may include sources of bills, amounts of bills, timeliness of payments of bills, money transfers, purchases or sales of bonds or stocks, etc. Account context may include the account balance, lines of credit available to the account, outstanding debts to be paid from the account, etc. From the observed interactions and the records of the user's past interactions with the account, account management system 14 may determine the historical financial behavior patterns of the user. Based on the historical financial behavior patterns of the user, account management system 14 may generate computer-learned rules describing the patterns.

In some examples, account management system 14 may access records of historical financial data of one or more other users with an account provided by organization 10, such as a population of users belonging to a substantially similar demographic as the user. Such information may be used to determine historical financial behavior patterns of an average user having similar demographics as the user.

In some examples, account management system 14 may include a model configured to determine patterns of behavior from historical financial data. The model may be constructed from historical financial data, including transaction data (sources of bills, amounts of bills, timeliness of payments of bills, money transfers, purchases or sales of bonds or stocks, etc.) and account context data (the account balance, lines of credit available to the account, outstanding debts to be paid from the account, etc.). The model is configured to accept financial event data as input and to supply an action in response to the financial event data as output. A model trained on historical financial data for a user may predict how the user may respond to the financial event data. The output of the model may reflect if, how, and/or when a user would respond to the financial event data. Patterns of behavior implicit in the model may include a frequency with which the user makes payments to certain institutions, periodic increases or decreases in spending, the user's top categories of purchase, or the user's most common strategy for handling low credit availability. The model may determine additional or alternative patterns relating to the user's management of the account.

In other examples, account management system 14 may train a model on historical financial data of one or more other users with an account provided by organization 10. Such models may predict responses of an average user to financial event data.

For example, account management system 14 may train a machine learning model based on the historical financial data of the user and the historical financial data of a population of users belonging to a substantially similar demographic as the user. The population of users may, for example, have a similar annual income, accumulated savings, accumulated debt, credit score, geographic location, cost of living, lifestyle, family, etc., to the user. The user may provide a preference of the population of users. For example, the user may specify that the population must include one or more members of the user's community, such as a family member. Account management system 14 may determine, from the machine learning model, the historical financial behavior patterns of the user and the historical financial behavior patterns of the population of users. Account management system 14 may generate computer-learned rules based on the historical financial behavior patterns of the user and on the historical financial behavior patterns of the population of users.

Account management system 14 may also determine user-defined rules from user priorities, preferences, and/or boundaries. For example, user-defined rules may include a priority of paying bills on time, a preference for a minimum balance in a checking account, a preferred credit score minimum, and/or a boundary for an average monthly size of financial gifts to recipients. Account management system 14 may determine the user-defined rules from input from the user. Account management system 14 may send data representative of a user interface to user device 18 to receive the user-defined rules as input to user device 18.

In the supervising stage, account management system 14 may monitor events in the account in real-time or near real-time, predict the user's actions in response to the events using the one or more models constructed in the learning stage, and compare the predictions to the user's actions. In response to a discrepancy between a prediction and the user's action, account management system 14 may consider the user's action to be an anomaly and thus a sign of user incompetence (e.g., due to age or cognitive decline). In some examples, the anomaly may be an unprecedented purchase of a gift card of a large sum, a check written to an unrecognized recipient, or an unusual failure to pay a bill.

In some examples, account management system 14 monitors for a threshold number of anomalous activities before assuming control. In other examples, account management system 14 monitors for a threshold rate of anomalous activities (i.e., a certain number of anomalies over a certain duration of time).

Account management system 14 may identify the one or more anomalous financial transactions by comparing the monitored financial behavior of the user to the historical financial behavior patterns of the user. Account management system 14 may determine that the anomalous activities, as a sign of user incompetence, may constitute a status change of the user. As a result, account management system 14 may, with the user's permission or prior permission, assume control over the user's account (potentially overruling the user's current judgement). By recognizing unusual behavior, account management system 14 may further serve as an identity management or identity protection tool or may be a part of an identity management or identity protection system.

In the execution stage, with the user's permission, account management system 14 executes automatic financial decisions in the user's account. Account management system 14 monitors the account for financial events, determines a likely response by the user from the user-defined rules and the computer-learned rules, and executes the response. The response may include refusing to pay unfamiliar bills, periodically paying off debt, determining whether to renew a certificate of deposit at its maturity date or withdraw the principal plus interest, and maintaining an account context (e.g., account balance, outstanding debt, etc.) similar to when the user managed the account.

Account management system 14 begins the execution stage as a result of a status change of the user. The status change may correspond to a preplanned date or may correspond to anomalous behavior observed during the supervising stage. For example, the user may schedule the execution stage due to an expected absence (e.g., a medical procedure or travel). Account management system 14 may determine the status change of the user from receiving the status change indication from user device 18. The status change may include at least a start date of the status change during which the user plans to be unavailable to control the account, where account management system 14 assumes control of the account on the start date. The status change indication may further include at least one of a duration or an end of the status change of the user, where account management system 14 relinquishes control of the account either after the duration has expired or on the end date.

As another example, the user may have permitted, via user device 18, account management system 14 to decide when to manage financial activities in case of the user's forgetfulness, gullibility, or confusion due to age or cognitive decline. Account management system 14 may determine the status change by identifying one or more anomalous financial transactions initiated by the user from the monitored financial behavior of the user and, based on a number of the anomalous financial transactions identified within a period of time being greater than a threshold, determining the status change of the user during which the user is deemed to be incapable of controlling the account, where account management system 14 assumes control of the account immediately.

In other examples, the status change may be the user's death. The user may have permitted, via user device 18, account management system 14 to perform predetermined tasks in the event of the user's death. Account management system 14 may receive notification from server 12 of the user's death and may perform tasks such as closing out financial and/or social media accounts, maintaining financial and/or social media accounts, or mediating between members of the user's community on behalf of the user regarding financial and/or social media accounts. Account management system 14 may maintain a record of passwords to some accounts provided by the user in order to perform tasks. Server 12 may block access by account management system 14 to the passwords until the user's death, at which point server 12 may unlock access to the passwords.

Account management system 14 may alert the user to the status change. Prior to assuming control of the account, account management system 14 may send a notification to user device 18 indicating the determined status change of the user and indicating that account management system 14 will assume control of the account unless the user overrides the determined status change. The user may override the status change determination via user device 18.

During the execution stage, the user may maintain varying degrees of participation in the account management. In some examples, account management system 14 may assume shared control of the account such that the user or another human retains at least partial control of the account (e.g., the user can only use a credit card at designated locations, the user cannot open new credit cards, the user cannot spend more than a maximum amount of money in one purchase, etc.). In other examples, account management system 14 may assume full control of the account such that the user or another human has no control to the account.

Prior to assuming management, account management system 14 may require permission from the user via user device 18 to manage the account. The user gives permission for account management system 14 to enter the learning stage, the supervising stage, or the execution stage. The user may have an option to activate or deactivate the learning stage, the supervising stage, or the execution stage.

Activities during automatic account management may be the output of the machine learning model. Before executing a decision, account management system 14 may also reference rules defined by the user. User-defined rules may include a priority of paying bills on time, a preference for a minimum balance in a checking account, a boundary for an average monthly size of financial gifts to specified recipients, etc.

Account management system 14 may execute a financial transaction on behalf of the user by applying a financial event as input to the computer-learned rules. For example, the computer-learned rules may include a machine learning model trained on the historical financial data of the user. Account management system 14 may receive, as output from the computer-learned rules, one or more likely responses by the users. The likely responses may be financial transactions that the user would be likely to make in response to the financial event. Account management system 14 may compare the likely responses to the user-defined rules, which may include preferences of the user. Account management system 14 may select one of the likely responses based on the respective similarities of the likely responses to the user-defined rules. Account management system 14 may execute the selected likely response on behalf of the user.

In one example of the execution stage, the user's account may receive a request (e.g., a bill), and account management system 14 may identify the request. For example, account management system 14 may recognize that the request is a utility bill or a doctor's bill, a transfer request from BillPay, a rebalancing request from a brokerage account, or a cash withdrawal request. Account management system 14 may apply the request to a model that describes patterns in the user's behavior. The model might consider details including the requester, the response due date, the frequency of requests, etc. Account management system 14 may determine if the user has user-defined rules about handling the identified type of bill or about managing the account in its current state (e.g., maintaining a minimum account balance, never paying amounts greater than a maximum amount, never overdrawing the account, etc.). Account management 14 may then execute an action output by the model in view of user-defined rules.

In some cases, such as when the user is suffering from old age or cognitive decline, account management system 14 may continue managing the account indefinitely while the user is living. In other cases, such as when the user has a short-term illness or a scheduled absence, account management system 14 may receive indication of a second status change of the user. In some examples, such as when the user schedules a return to the user's autonomous control, account management system 14 may interpret the scheduled return as a second status change and relinquish control of the account on an end date provided by the user or after a duration provided by the user has expired. In other examples, such as when the user rejects the automatic assumption of duties by account management system 14, account management system 14 may interpret the rejection as a second status change and relinquish control of the account immediately.

Account management system 14 may provide a report of tasks performed in the account. The report may include a record of recently completed tasks, a record of debt in the account, or a record of conformation to the user-defined rules. The report may include results of evaluation tests on the model. The report may further include an evaluation of the account, such as a credit score. Account management system 14 may provide the report via user device 18. Account management system 14 may, according to instructions provided by the user, alert the user or a member of the user's community about the availability of the report, such as by email.

In this way, account management system 14 may be able to recognize a user's inability to manage an account, anticipate a user's decision, and automatically respond to an event in the account as the user would. The one or more models may enable account management system 14 to be faster and/or more accurate than other computer systems or account management by human users. For example, a user may not have to attempt to communicate all preferences to a third party or trust the third party. The third party may not have to guess the user's preferences or otherwise directly manage the account. In this manner, the models of account management 14 may reduce or eliminate human error and malicious activity, resulting in more accurate or appropriate account management.

In some examples, the one or more models of account management system 14 may also be faster and more holistic than other third-party systems due to the efficiency and breadth of the prediction of the user's response to an event. For example, in other management systems, account management may only process individual requests and fail to consider the context of the account (e.g., account balances, credit availability, outstanding debt, etc.) before executing the request. The computation speed of the model may enable account management system 14 to have an overall view of the account, which may enable more accurate account management and preclude the relatively ad hoc management manner of other third-party computer systems. Thus, account management 14 may provide the user with suitable account management in the user's absence, which may help prevent the user from triggering fees or accumulating debt.

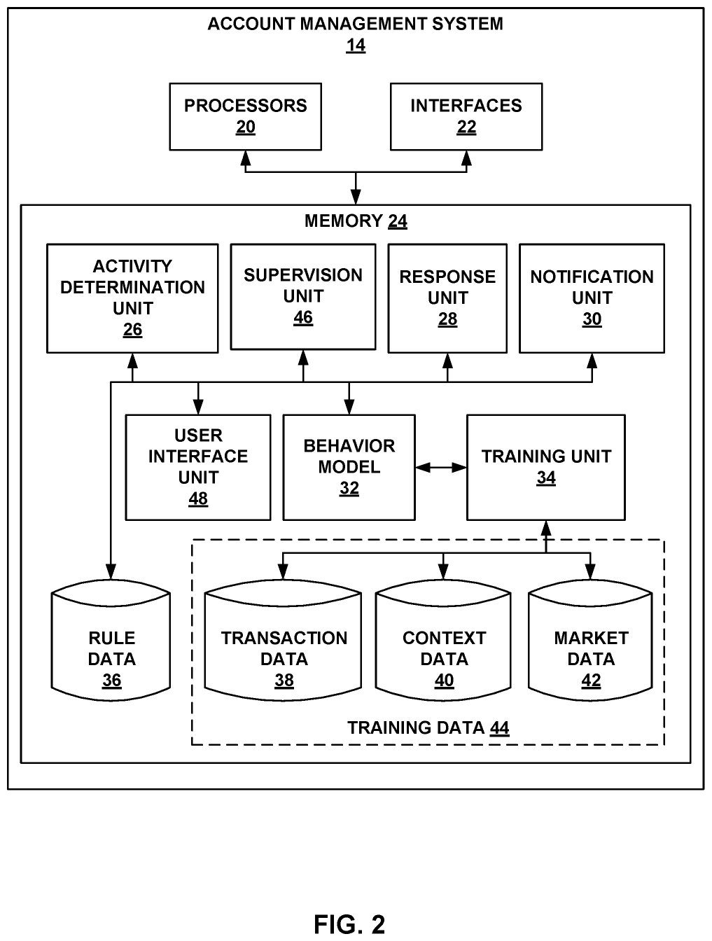

FIG. 2 is a block diagram illustrating the example account management system 14 of FIG. 1, in greater detail. The architecture of account management system 14 illustrated in FIG. 2 is shown for exemplary purposes only and account management system 14 should not be limited to this architecture. In other examples, account management system 14 may be configured in a variety of ways.

As shown in the example of FIG. 2, account management system 14 includes one or more processors 20, one or more interfaces 22, and one or more memory units 24. Memory 24 of account management system 14 includes user interface unit 48, activity determination unit 26, supervision unit 46, response unit 28, notification unit 30, behavior model 32, and training unit 34, which are executable by processors 20. Memory 24 also includes rule data 36 and training data 44 (e.g., transaction data 38, context data 40, and market data 42). Each of the components, units, or modules of account management system 14 are coupled (physically, communicatively, and/or operatively) using communication channels for inter-component communications. In some examples, the communication channels may include a system bus, a network connection, an inter-process communication data structure, or any other method for communicating data.

Processors 20, in one example, may include one or more processors that are configured to implement functionality and/or process instructions for execution within account management system 14. For example, processors 20 may be capable of processing instructions stored by memory 24. Processors 20 may include, for example, microprocessors, digital signal processors (DSPs), application specific integrated circuits (ASICs), field-programmable gate arrays (FPGAs), or equivalent discrete or integrated logic circuitry, or a combination of any of the foregoing devices or circuitry.

Account management system 14 may utilize interfaces 22 to communicate with external devices via one or more networks (e.g., network 16), or via wireless signals. Interfaces 22 may be network interfaces, such as Ethernet interfaces, optical transceivers, radio frequency (RF) transceivers, or any other type of devices that can send and receive information. Other examples of interfaces may include Wi-Fi, near-field communication (NFC), or Bluetooth® radios. In some examples, account management system 14 utilizes interfaces 22 to communicate with an external device such as a server associated with organization 10, a server associated with network 16, user device 18, etc.

Memory 24 may be configured to store information within account management system 14 during operation. Memory 24 may include a computer-readable storage medium or computer-readable storage device. In some examples, memory 24 includes one or more of a short-term memory or a long-term memory. Memory 24 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, memory 24 is used to store program instructions for execution by processors 20. Memory 24 may be used by software or applications running on account management system 14 (e.g., user interface unit 48, activity determination unit 26, supervision unit 46, response unit 28, notification unit 30, behavior model 32, and/or training unit 34) to temporarily store information during program execution.

User interface unit 48 of account management system 14 may generate and send data representative of a user interface to a user device, such as user device 18 from FIG. 1, to receive the user-defined rules and expectations as input to the user device from the user. The user interface may include an activation option for the user to allow account management system 14 to monitor the user's financial activities and to build models of the user's financial behavior. The user interface may further include an option for the user to allow account management system 14 to start executing decisions at an exact date or in response to detecting anomalous behavior by the user. In addition, the user interface may allow the user to specify whether the user should have access to accounts while account management system 14 is executing decisions. The user interface may further enable the user to indicate preferences on tasks account management system 14 should perform in response to the user's death (e.g., close or administer a financial and/or social media account on behalf of the user). The user may input, at the user interface, a password to enable account management system 14 to close or administer an account after the user's death.

The user interface generated by user interface unit 48 may further enable the user to specify significant dates, contact information, dollar amounts, or other preferences. For example, the user may input dates for account management system 14 to begin and end automated decision execution. In another example, the user may input one or more mobile phone numbers (e.g., of the user, of the user's family, etc.) that account management system 14 should notify when beginning automated decision execution. As yet another example, the user may input a minimum balance amount for account management system 14 to maintain in the user's checking account. As yet another example, the user may input additional preferences such as how to react to crisis situations, how to manage gift-giving, or how to prioritize accumulating savings versus paying off long-term debt.

In some cases, the user may respond to direct questions presented via the user interface (e.g., “When should automated decision-making start?”, “Who should be contacted when automated decision-making starts?”, “What minimum balance should be maintained in your checking account?”, etc.). In other cases, the user may respond to story-based questions presented via the user interface (e.g., “If you receive a notification suggesting your credit card has been stolen, what would you do?”, “If your child is getting married, how much money would you give your child as a gift?”, “If you have a monthly income of $4,000, how much money would you apply to the following categories: savings, paying off a mortgage, and everyday expenses?”, etc.).

User interface unit 48 may prioritize questions included in the user interface and include high priority questions early on in the layout of the user interface. For example, questions with a high priority may concern the user's comfort level with account management system 14 automatically beginning decision execution without the user providing a start date (e.g., in response to detecting anomalous behavior). In contrast, questions with a low priority may concern the user's preference for a day of the month to pay bills.

User interface unit 48 may generate the data representative of the user interface to include multiple choice questions (e.g., radio boxes or checkboxes), text boxes for free-form input, and/or range sliders. User interface unit 48 may send prompts for the user to confirm and/or modify answers periodically, such as monthly, semiannually, annually, or biannually. User interface unit 48 may generate and send data representative of user interfaces including new questions or the same questions presented in different ways as a method of confirming the user's answers. User interface unit 48 may gamify the questions included in the user interface to encourage the user to supply several informative answers, such as by rewarding the user for responding to a goal number of questions, for answering with a high level of specificity (e.g., nonzero dollar amounts, verifiable contact information, etc.), or for answering a question with a high priority. In general, input by the user via the user interface will be referred to as “user-defined rules.” User-defined rules may be stored in memory 24 as rule data 36.

User interface unit 48 may provide the user with data about account management system 14. The data about account management system 14 may empower the user to make an informed decision about entrusting account management system 14 with control over the user's account. For example, the user may view the accuracy and sensitivity of the one or more models used for predicting the user's actions (e.g., behavior model 32). The user may view the predictions made by the one or more models. Based on such information, the user may confirm that account management system 14 will act in the user's best interests. In some examples, user interface unit 48 may generate and send to user device 18 data representative of user interfaces to receive access control information from the user. For example, the user may have an option in the user interface to activate or deactivate a part of or all of account management system 14. Account management system 14 may provide the user with one or more reports on one or more financial transactions that account management system 14 makes on behalf of the user. The reports may be sporadic (e.g., based on an occurrence of a certain event) or periodic (e.g., based on a certain time period). Account management system 14 may provide the reports via user interface unit 48 as data representative of user interfaces sent to user device 18, or via notification unit 30 as an email or push notification to user device 18.

Activity determination unit 26 may monitor information relating to financial events and the user's actions in response to the financial events in an account. For example, activity determination unit 26 may monitor information such as deposits, withdrawals, transfers, bills, payments, calendar dates, geolocation of purchases, and/or context information (e.g., account balance, available lines of credit, outstanding debts, etc.). Financial events and the user's actions in response to the financial events may be stored in memory 24 as transaction data 38 and context data 40.

Activity determination unit 26 is configured to determine historical financial behavior patterns of the user based on historical financial data of the user. In some cases, activity determination unit 26 determines patterns and takes no further action. In other cases, activity determination unit 26 determines patterns and enables supervision unit 46 to compare the patterns to current user actions in real-time and thereby monitor for anomalous behavior. In other cases, when account management system 14 has assumed control of the account, activity determination unit 26 determines patterns and enables response unit 28 to execute an action based on the patterns in response to new financial events.

In some examples, activity determination unit 26 may compare time-series historical financial data in the account (e.g., stored as transaction data 38) to determine a user's common responses to common financial events. In other examples, activity determination unit 26 may associate the time-series historical financial data with relevant context data and market data (e.g., stored as context data 40 and market data 42) such as associating a failure to pay off a credit line with a low account balance. In some examples, activity determination unit 26 may determine cause-and-effect patterns in the user's historical financial data. In other examples, activity determination unit 26 may analyze historical financial data of one or more other users with an account provided by organization 10 and use such information to determine historical financial behavior patterns of an average user.

In some examples, activity determination unit 26 may determine the historical financial behavior patterns using behavior model 32. For example, activity determination unit 26 may apply the historical financial data (e.g., past transactions, contextual information, market data, etc.) as input into behavior model 32, and behavior model 32 may determine the user's likely responses as output based on the input information. In some examples, the input corresponds to events in the user's account, and the output corresponds to predictions of the user's responses. In other examples, the input corresponds to events in the accounts of one or more other users, and the output corresponds to predictions of an average user's responses. In general, predictions determined by activity determination unit 26 will be referred to as “computer-learned rules.” Computer-learned rules may have respective likelihood scores quantifying the robustness of the rules.

In some cases, behavior model 32 may be one or more machine learning models. In some examples, training unit 34 may train behavior model 32 from one or more machine learning algorithms based on training data 44 including historical transaction data 38 in the account and/or historical context data 40 of the account along with market data 42. More specifically, training data 44 may include, for example, previous months or years of transaction data 38, context data 40, and/or market data 42. Once trained, behavior model 32 may be able to predict actions in response to new input data based on trends, patterns, or insights determined from training data 44. For example, the patterns identified during the training of behavior model 32 may include a correlation between an event in an account and a user's response. In this way, behavior model 32 may identify a group of patterns based on the new input data from activity determination unit 26 (e.g., the information monitored by activity determination unit 26), and each pattern of the group of patterns may have a known degree of influence on possible responses from the user (e.g., whether the user would buy a stock at a certain price, whether the user would contest a transaction from a foreign country, etc.). Using the patterns, behavior model 32 determines a likely response of the user to the new input data. For example, behavior model 32 may be trained to recognize that a pattern including a low account balance and an increase in retail purchases on a credit card in the month of December is normal (e.g., not suggestive of card theft) and may warrant transferring money from a savings account into a checking account before paying off the credit card to avoid an interest charge or an overdraft fee. Once a likely action of the user has been determined, behavior model 32 may output the predicted one or more actions to activity determination unit 26.

In some cases, one or more machine learning models of behavior model 32 may be trained on training data 44 generated based on historical financial data from one or more other users and, thus, may output one more predicted actions of an average user. The one or more other users may belong to a population of users having a similar demographic to the user of the account. Determining a similar demographic may include considering an annual income, accumulated savings, accumulated debt, a credit score, a geographic location, a cost of living, a lifestyle, a family, etc., of the user. As a result, the average user represented by the one or more other users may be comparable to the user of the account. Modeling the behavior of the average user may offset a lack of historical financial data in the account of the user (e.g., in the case of a rare financial event or a relatively short history of financial data from the user).

Training unit 34 may use training data 38 to train behavior model 32 to determine likely actions of a user (e.g., the user of the account or the average user). In some examples, training data 44 may include transaction data 38, context data 40, and/or market data 42 with known potential effects on a subsequent action by the user. For example, training data 44 may include transaction data 38, context data 40, and/or market data 42 that resulted in a payment, a transfer, or an alert.

In some examples, transaction data 38 may include bills, billers, payments, recipients, methods of payment, withdrawals, geolocations, dates, etc. As shown in FIG. 2, transaction data 38 may be stored in memory 24 of account management system 14. Transaction data 38 may be acquired by activity determination unit 26 while monitoring the user's activity. Additionally or alternatively, account management system 14 may receive or otherwise access transaction history from organization 10 (e.g., using user interface unit 48) and store the data in transaction data 38. Training unit 34 may use any suitable transaction data 38 relevant to train behavior model 32. In some examples, transaction data 38 may include different purchases made from different credit cards, or different billed amounts paid in full or in monthly installments. In one example, a utility bill may be most likely to be paid from a credit card account, while a doctor's bill may be most likely to be paid from an HSA account separate from the credit card account. As another example, credit cards might always be paid off every month, but a car loan may remain outstanding with only a partial payment each month.

Context data 40 may include information such as, for example, account balances, available credit, outstanding debts, etc., with known potential effects on the user's actions. As one example, a low account balance may result in a transfer from another account. As another example, available credit may result in a bill being paid through the corresponding credit line. As yet another example, outstanding debt may result in paying an interest charge. In other examples, context data 40 may include additional or alternative information with potential known effects on the user's actions.

Market data 42 may include data about loan interest rates and/or investment prices (e.g., stocks, bonds, commodities, currencies, etc.), with known potential effects on the user's actions. As one example, a low loan interest rate may result in refinancing a mortgage. As other examples, high and falling stock prices may result in selling stock, while low and rising stock prices may result in buying stock, while turbulent stock prices may result in no action. In other examples, market data 42 may include additional or alternative information with potential known effects on the user's actions.

In some examples, training unit 34 may apply training data 44 to a machine learning algorithm, such as a recurrent neural network (RNN), to create behavior model 32 used by activity determination unit 26 to determine one or more likely actions of the user. The RNN algorithm may identify patterns and relationships associated with transaction data 38, context data 40, and/or market data 42 of training data 44. In other examples, training unit 34 may apply training data 44 to a different machine learning algorithm, such as, for example, a Bayesian algorithm, a clustering algorithm, a decision-tree algorithm, a regularization algorithm, a regression algorithm, an instance-based algorithm, an artificial neural network algorithm, a deep learning algorithm, a dimensionality reduction algorithm, etc., to create behavior model 32.

In some examples, behavior model 32 may be periodically retrained by training unit 34. Behavior model 32 may be initially created by training unit 34 based on training data 44 including a first training set (e.g., a first set of transaction data 38, context data 40, and/or market data 42), and training unit 34 may retrain behavior model 32 when appropriate using a second training set (e.g., a second set of transaction data 38, context data 40, and/or market data 42). In some examples, the second training data set may include some or all of the training data included in the first training data set. In other examples, the second training data set may not include any training data of the first training data set (i.e., all new training data). In any case, training unit 34 may retrain behavior model 32 using the second training data set. After behavior model 32 has been retrained, behavior model 32 may be different than the previous behavior model 32 trained using the first training data set.

In some examples, training unit 34 retrains behavior model 32 on regular time intervals (e.g., monthly, bimonthly, yearly, etc.). In other examples, training unit 34 may retrain behavior model 32 on an irregular basis, such as based on reduced accuracy of behavior model 32. For instance, if the accuracy of behavior model 32 is determined to be reduced and/or fall below a threshold accuracy limit (e.g., 95%), behavior model 32 may be retrained using new data to better fit new patterns of the user's financial activity. For example, training unit 34 may retrain behavior model 32 if account management system 14 receives notification from the user (e.g., via user interface unit 48) that an action by account management system 14 was not similar to the user's preferences. As another example, if the account is incurring penalties such as overdraft fees or interest charges while maintaining high account balances or credit availability in some accounts, the discrepancy may cause training unit 34 to retrain behavior model 32. Such examples may indicate that behavior model 32 has reduced accuracy. In other examples, additional or alternative situations may also indicate that behavior model 32 may have reduced accuracy, which may trigger the retraining of behavior model 32 by training unit 34.

In some examples, training unit 34 monitors the accuracy of behavior model 32. For example, the various data included in training data 44 may affect a response of the user in an identifiable way. As an example, training data 44 that includes transaction data 38 with a record of a bill received and a record of the bill payment thus identifies an action of the user in response to an event in the account. To determine the accuracy of behavior model 32, training unit 34 may use similar events with identifiable responses from a subset of training data 44 as input to behavior model 32 and may determine a fraction of events in which behavior model 32 correctly outputs the user response. As an example, a first set of training data 44 (e.g., a first set of transaction data 38, context data 40, and/or market data 42) with known event-and-response relationships may be separated from a second set of training data 44 (e.g., a second set of transaction data 38, context data 40, and/or market data 42) with known event-and-response relationships, with the first set used to train behavior model 32 and the second set used to validate behavior model 32. The percentage of accurate output from the second set may represent a measured accuracy of behavior model 32. In some cases, data other than training data 44 may be used to determine the accuracy of behavior model 32. In such examples, the data used to determine the accuracy of behavior model 32 may have a known effect on the user's actions so that training unit 34 can determine whether behavior model 32 output the most likely user action. In some cases, if the measured accuracy of behavior model 32 decreases, training data 34 may retrain behavior model 32.

Each output from behavior model 32 may correspond to one or more predictions of the user's response to the input or of the average user's response to the input. Activity determination unit 26 may use the output from behavior model 32 as computer-learned rules. Activity determination unit 26 may assign a score to each of the computer-learned rules. The score may reflect the likelihood of the computer-learned rule being correct. In some examples, the score depends on the accuracy of the model that produced the computer-learned rule (e.g., a prediction from a model with a higher accuracy score is assigned a higher likelihood score). Alternatively or additionally, the score may depend on the number of models that produced the same prediction (e.g., if more models agree on a prediction, then the corresponding computer-learned rule is assigned a higher likelihood score), or the score may depend on whether the model represents behavior of the user of the account or of the average user. For example, the score for the model representing the behavior of the average user may be higher if the predictions of the one or more models representing the user of the account are highly disparate (e.g., due to the event being rare in the user's account). Such examples may contribute to the likelihood scores of the computer-learned rules. In other examples, additional or alternative criteria may also affect the likelihood scores assigned by activity determination unit 26. In some examples, activity determination unit 26 may determine a subset of computer-learned rules whose likelihood scores satisfy a threshold likelihood score. That is, the subset may only include computer-learned rules that are determined to have at least some minimum likelihood of being correct.

After behavior model 32 has been trained, supervision unit 46 may monitor the user in real-time by comparing the computer-learned rules of activity determination unit 26 with the user's response. In some cases, the computer-learned rule matches the user's response, and no further action is taken. In other cases, the computer-learned rule does not match the user's response. In such cases, supervision unit 46 may determine that the user is exhibiting anomalous behavior, perhaps due to incompetence (e.g., stress, sickness, confusion, etc.). In some examples, supervision unit 46 monitors for a threshold number of anomalous activities. In other examples, supervision unit 46 monitors for a threshold rate of anomalous activities (i.e., a certain number of anomalies over a certain duration of time).

As previously permitted by the user, supervision unit 46 may determine that the anomalous behavior corresponds to a status change in the user, and account management system 14 may assume management duties of the account.

Notification unit 30 may send a notification to the user (e.g., via user device 18) informing the user of the status change and assumption of management duties. The user may have the option to override or reject the status change and the assumption of management duties by account management system 14. For example, the notification may prompt the user to enter a PIN, password, or other security token to override the status change and the related decision of account management system 14 to assume control of the user's accounts.

In this way, in some cases, supervision unit 46 initiates the assumption of management duties by account management system 14. In other cases, account management system 14 may receive from user device 18 via user interface unit 48 a scheduled status change. A scheduled status change may be due to the user's unwillingness to manage the account (e.g., due to travel, hospitalization, etc.) and may include a date and/or time for account management system 14 to assume management duties. Account management system 14 may assume management duties at the specified date and time. The status change may further include a duration of the status change or, similarly, an end date of the status change, during which the user relinquishes all or partial control of the account.

In other cases, account management system 14 may assume management duties based on the user's death. Account management system 14 may identify the death of the user (e.g., due to a notification from server 12). In response to identifying the death, account management system 14 may manage the user's account according to one or more preferences previously indicated by the user. In one example scenario, account management system 14 may already have assumed management duties as described above due to either an observed or scheduled status change of the user while alive. Upon identifying the death of the user, account management system 14 may continue to manage the user's financial accounts in a similar manner.

In addition, upon identifying the death of the user, account management system 14 may perform several additional tasks such as closing out certain financial and/or social media accounts of the user, maintaining certain financial and/or social media accounts of the user, and/or mediating between members of the user's community on behalf of the user regarding financial and/or social media accounts of the user. In some examples, account management system 14 may maintain a record of passwords to some accounts, e.g., social media accounts, provided by the user while alive in order to perform the tasks. For example, the record of passwords may be stored in rule data 36 or another database either within account management system 14 or external to account management system 14. Response unit 28 may obtain access to the record of passwords, and thus access to the password-protected accounts, only upon the user's death.

In some further examples, upon identifying the death of the user, account management system 14 may begin managing the financial and/or social media accounts of the user on behalf of another human, i.e., not the deceased user. For example, account management system 14 may immediately or gradually be trained to make decisions representative of the other human's behavior, as opposed to the user's behavior. In some examples, the other human may be the deceased user's heir, the administrator of the deceased user's estate, or the trustee of the deceased user's trust(s).

Once account management system 14 has assumed management duties for the user's accounts, with the permission of the user, response unit 28 may determine to initiate a response to a new financial event in the account. Response unit 28 may use a set of computer-learned rules as determined by activity determination unit 26 and user-defined rules from rule data 36. User-defined rules may include user priorities, preferences, and/or boundaries. For example, the user may specify a priority of paying bills on time, a preference for a minimum balance in a checking account, and/or a boundary for an average monthly size of financial gifts to recipients. User-defined rules may vary in importance, as indicated by the user. For example, some rules may be more important to the user than other rules, or the user may perceive all rules as equally important. Response unit 28 may assign an importance score to each rule in rule data 36 to reflect the user's indicated level of importance.

Response unit 28 may use the computer-learned rules and user-defined rules to determine how account management system 14 will respond to an event in the account. For example, due to a high likelihood score for a computer-learned rule to pay off a credit card after receiving a bank statement, response unit 28 may determine to pay off a credit card in response to the account receiving a bank statement. As another example, due to a user-defined rule of giving a gift to a child on the child's birthday, response unit 28 may determine to transfer money to the child's account on that day.

Response unit 28 may determine an action of varying likelihood, of varying cost to the account, and/or of varying conformity to the user-provided rules. In some examples, response unit 28 may determine an action that is of low likelihood to match the user's response but is of least cost to the account and most conforms to the user-provided rules. For example, the user may not always pay bills on time, but response unit 28 determines to pay bills on time in order to avoid late fees and to follow the user's priority of paying bills on time. In other examples, response unit 28 may determine an action that is of high likelihood to match the user's response but is more costly than other potential actions and conflicts with user-provided rules. For example, response unit 28 may pay off only a portion of an auto loan in accordance with the user's behavior of only paying off monthly installments, even though the partial payment accrues interest charges and conflicts with the user's preference to pay off all debt as quickly as possible. Such examples of actions have some varieties of likelihood, costliness, and conformity that response unit 28 may determine. In other examples, additional or alternative varieties of likelihood, costliness, and conformity in responses may also be determined.

In some examples, response unit 28 may determine a response by applying an optimization algorithm, such as a divide-and-conquer algorithm, to the set of computer-learned rules and user-defined rules with their respective scores. The optimization algorithm may maximize the likelihood of the response matching the user's response, while minimizing the cost to the account and maximizing the conformity to the user-defined rules. In other examples, response unit 28 may apply a different optimization algorithm to the set of computer-learned rules and user-defined rules with their respective scores, such as, for example, dynamic programming or greedy algorithms.

Notification unit 30 may initiate the response determined by response unit 28. In some examples, notification unit 30 may trigger the account to authorize a withdrawal, pay the balance on a credit card, sell stock, transfer money, etc. In another example, having received notification from organization 10 that a credit card has shown fraudulent activity, notification unit 30 may request that the credit card be cancelled and reissued. Such examples illustrate activity initiated by notification unit 30. In other examples, additional or alternative activity may also be initiated.

While account management system 14 has assumed account management responsibilities and response unit 28 automatically is responding to events in the account, the user may have one of various levels of access to the account. The level of access may be determined via user interface unit 48 before account management system 14 assumes control over the account. In some cases, the user may have full access to the account and may continue to interact with it freely. In such cases, account management system 14 shares control of the account with the user. In other cases, the user may have limited access to the account (e.g., may not be able to make payments to money requests, may have restrictions on spending, may not be able to open new credit cards, etc.). In such cases, account management system 14 may assume full control of the account during which the user has little or no control over the account.

Account management system 14 may receive indication of a second status change of the user from user device 18 via user interface unit 48. In some examples, account management system 14 may receive a rejection of the determination by activity determination unit 26 to assume account management duties. In other examples, account management system 14 may receive notification of a scheduled status change (e.g., new willingness and/or ability to manage the account). Account management system 14 may cease management duties of the account at a certain time based on the indication of the status change.

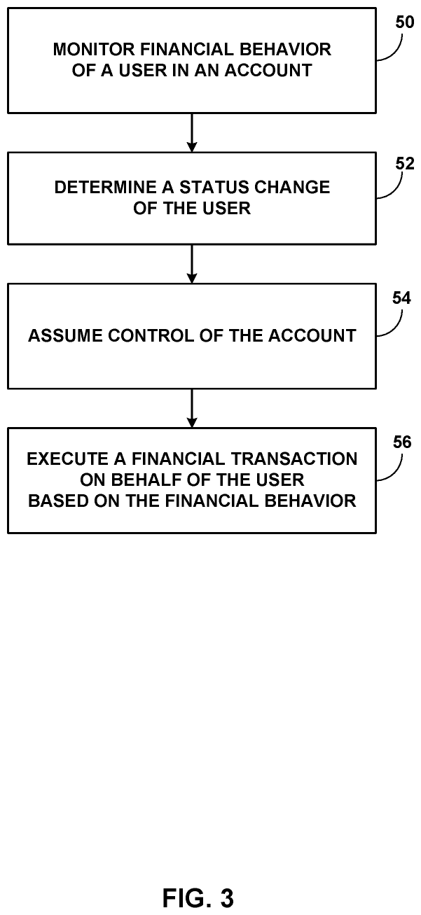

FIG. 3 is a flow diagram illustrating an example technique of assuming management duties of an account, in accordance with the disclosure. The technique of FIG. 3 will be described with respect to account management system 14 of FIG. 2 for ease of description only. In other examples, other systems may be used to perform the technique of FIG. 3.

The technique of FIG. 3 includes activity determination unit 26 monitoring financial behavior of a user in an account (50). Financial behavior may include user responses to events in the account. For example, activity determination unit 26 may monitor information like bills, payments, withdrawals, transfers, account balances, credit availability, debts, and/or other information of transactions in the account and context of the account.

Account management system 14 may determine a status change of the user (52). In some cases, account management system 14 may receive a notification from user device 18 via notification unit 30 of a scheduled status change. The scheduled status change may correspond to the user foreseeing an unavailability to manage the account (e.g., due to hospitalization, travel abroad, lack of time, etc.) and a desire for account management system 14 to manage the account instead. The user may provide, via user device 18, a start date of the planned absence, a duration of the planned absence, an end date of the planned absence, and/or a preference for account management system 14 to have shared control or full control over the account during the absence.

In other cases, supervision unit 46 may determine from a set of computer-learned rules that a response from the user to an event in the account was anomalous. The computer-learned rules may be historical financial behavior patterns of the user, as determined by behavior model 32 based on historical financial data of the user. While monitoring the user behavior, supervision unit 26 may input a new event into behavior model 32, and behavior model 32 may output likely responses by the user. The computer-learned rules may include the outputs from behavior model 32. Supervision unit 46 may further monitor the account for the user's response to the event and compare the user's response to the computer-learned rules. In cases where the user's response does not match the computer-learned rules, supervision unit 46 may determine that the user is exhibiting anomalous behavior, perhaps due to incompetence (e.g., stress, sickness, confusion, etc.). In some examples, supervision unit 46 monitors for a threshold number of anomalous activities. In other examples, supervision unit 46 monitors for a threshold rate of anomalous activities (i.e., a certain number of anomalies over a certain duration of time). Supervision unit 46 may determine that the one or more anomalous responses suggest a status change of the user.

Behavior model 32 may be a machine learning model trained on historical financial data of the user. Alternatively, behavior model 32 may be a machine learning model trained on the historical financial data of the user and on the historical financial data of a population of users belonging to a substantially similar demographic as the user, such that behavior model 32 may determine the historical financial behavior patterns of the user and/or of the population of users. Determining a similar demographic may include considering an annual income, accumulated savings, accumulated debt, a credit score, a geographic location, a cost of living, a lifestyle, a family, etc., of the user. In some examples, behavior model 32 may generate the computer-learned rules based on only the historical financial behavior patterns of the user. In other examples, behavior model 32 may generate the computer-learned rules based on the historical financial behavior patterns of the user and the historical financial behavior patterns of the population of users.

Based on the indication of status change, account management system 14 may assume control of the account (54). In cases where the user set a start date for account management system 14 to assume control of the account, account management system 14 may assume control on the start date. In other cases where supervision unit 46 determines a status change based on a number of anomalous financial transactions, account management system 14 may deem the user incapable of controlling the account and assume control of the account immediately. Notification unit 30 may send a notification to the user (e.g., via user device 18) informing the user of the status change and assumption of management duties. The user may have the option to override or reject the status change and assumption of management duties by account management system 14. For example, the notification may prompt the user to enter a PIN, password, or other security token to override the status change and related decision of account management system 14 to assume control of the user's accounts.

As permitted by the user, account management system 14 may execute a financial transaction on behalf of the user based on the user's financial behavior (56). Account management system 14 may determine to execute the financial transaction based on the computer-learned rules and/or the user-defined rules associated with the account. The financial transaction may include paying a bill, refusing to pay an unfamiliar bill, transferring money from a savings account to a checking account, paying off a credit card, paying a monthly installment on an auto loan, authorizing a withdrawal, buying stock, etc. Activity determination unit 26 may monitor the account for an event, may apply the event as input to behavior model 32, may receive as output from behavior model 32 predictions of the user's response to the event, and/or may determine a likelihood score of a computer-learned rule corresponding to each prediction. Response unit 28 may then determine, from the likelihood of the computer-learned rules and from the importance of user-defined rules from rule data 36, a response to the event and may initiate the event through notification unit 30.

In some cases, such as when the user is suffering from old age or cognitive decline, account management system 14 may continue managing the account indefinitely while the user is living. In other cases, such as when the user has a short-term illness or a scheduled absence, account management system 14 may receive indication of a second status change of the user. In some examples, account management system 14 may receive notification from user device 18 via notification unit 30 rejecting the determination by supervision unit 46 to assume account management duties. In other examples, account management system 14 may receive notification from user device 18 via notification unit 30 of a scheduled status change (e.g., a new willingness and/or ability to manage the account). In yet other examples, account management system 14 may relinquish control of the account on an end date provided by the user or after a duration provided by the user has expired. Account management system 14 may stop management duties of the account at a certain time based on the indication of the status change.

In some examples, the technique of FIG. 3 may further include training unit 34 training behavior model 32. For example, behavior model 32 may include one or more machine learning models, and training unit 34 may train behavior model 32 based on training data 44 including transaction data 38, context data 40, and/or market data 42. Additionally or alternatively, training unit 34 may train behavior model 32 based on data of other entities (e.g., other users with accounts provided by organization 10). Training unit 34 may also retrain behavior model 32. For example, training unit 34 may monitor the accuracy of behavior model 32 and retrain behavior model 32 when accuracy of behavior model 32 is determined to be reduced.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

In one or more examples, the functions described may be implemented in hardware, software, firmware, or any combination thereof If implemented in software, the functions may be stored on or transmitted over a computer-readable medium as one or more instructions or code and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM, or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry, as well as any combination of such components. Accordingly, the term “processor,” as used herein, may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method comprising:
training, by a computer system, at least one machine learning model based on historical financial data of a user and historical financial data of a population of users belonging to a substantially similar demographic as the user;
determining, from the at least one machine learning model, historical financial behavior patterns of the user and historical financial behavior patterns of the population of users;
generating, by the computer system, computer-learned rules based on the historical financial behavior patterns of the user and the historical financial behavior patterns of the population of users;
generating, by the computing system, user-defined rules based on input received from the user, wherein the user-defined rules include one or more of user-defined priorities or user-defined boundaries;
monitoring, by the computer system, financial behavior of the user in one or more financial accounts;
determining, by the computer system, a status change of the user in response to one of a status change indication received from a user device of the user or the monitored financial behavior of the user;
in response to the status change of the user, assuming, by the computer system, control of the one or more financial accounts, wherein assuming control comprises performing automated decision-making to manage the one or more financial accounts on behalf of the user;
upon assuming control of the one or more financial accounts, automatically initiating, by the computer system, a response to a payment event on behalf of the user, wherein automatically initiating the response to the payment event on behalf of the user comprises:
determining, based on output from the computer-learned rules, a set of likely responses by the user, wherein the set of likely responses includes one or more likely responses that are similar to actions previously made by the user, and wherein the one or more likely responses are one or more likely payment transactions with the one or more financial accounts in response to the payment event, and
after determining the set of likely responses, comparing the set of likely responses to the user-defined rules and selecting the response from the set of likely responses based on respective similarities, identified by the comparison, of the one or more likely responses included in the set of likely responses to the user-defined rules; and
executing, by the computing system, the response to the payment event on behalf of the user.

2. The method of claim 1, further comprising determining the historical financial behavior patterns of the user based on historical financial data of the user.

3. (canceled)

4. The method of claim 1, further comprising sending, by the computer system and to the user device, data representative of a user interface used to receive the user-defined rules as input to the user device.

5. The method of claim 1,
wherein determining the status change of the user comprises receiving the status change indication from the user device that includes at least a start date of the status change during which the user plans to be unavailable to control the one or more financial accounts; and
wherein assuming control of the one or more financial accounts comprises assuming control of the one or more financial accounts on the start date.

6. The method of claim 5, wherein the status change indication further includes at least one of a duration or an end date of the status change of the user, the method further comprising relinquishing control of the one or more financial accounts either after the duration has expired or on the end date.

7. The method of claim 1,
wherein determining the status change of the user comprises:
identifying one or more anomalous payment transactions initiated by the user from the monitored financial behavior of the user, and
based on a number of the anomalous payment transactions identified within a period of time being greater than a threshold, determining the status change of the user during which the user is deemed to be incapable of controlling the one or more financial accounts; and
wherein assuming control of the one or more financial accounts comprises assuming control of the one or more financial accounts immediately.

8. The method of claim 7, wherein identifying the one or more anomalous payment transactions comprises comparing the monitored financial behavior of the user to the historical financial behavior patterns of the user.

9. The method of claim 1, further comprising, prior to assuming control of the one or more financial accounts, sending a notification to the user device indicating the determined status change of the user and that the computer system will assume control of the one or more financial accounts unless the user overrides the determined status change.

10. The method of claim 1, wherein assuming control of the one or more financial accounts comprises assuming shared control of the one or more financial accounts during which the computer system performs automated decision-making to manage the one or more financial accounts on behalf of the user and one of the user or another human retains at least partial control of the one or more financial accounts to initiate a limited set of payment transactions with the one or more financial accounts.

11. The method of claim 1, wherein assuming control of the one or more financial accounts comprises assuming full control of the one or more financial accounts during which the computer system performs automated decision-making to manage the one or more financial accounts on behalf of the user and the user or another human has no control over the one or more financial accounts.

12. The method of claim 1, wherein automatically initiating the response to the payment event on behalf of the user further comprises:
applying the payment event as input to the computer-learned rules, wherein the computer-learned rules include the at least one machine learning model trained on the historical financial data of the user and the historical financial data of the population of users belonging to the substantially similar demographic as the user.

13. The method of claim 1, further comprising:
identifying a death of the user;
in response to identifying the death of the user, managing the one or more financial accounts according to one or more preferences previously indicated by the user; and
in response to identifying the death of the user, managing one or more social media accounts according to one or more preferences previously indicated by the user.

14. The method of claim 1, further comprising:
generating one or more reports on the one or more payment transactions with the one or more financial accounts that are automatically initiated by the computer system on behalf of the user in response to the payment event; and
outputting the one or more reports to one of the user device of the user or a computing device of another human.

15. A computer system comprising:
one or more memory units; and
one or more processors in communication with the memory units, the one or more processors configured to:
train at least one machine learning model based on historical financial data of a user and historical financial data of a population of users belonging to a substantially similar demographic as the user;
determine, from the at least one machine learning model, historical financial behavior patterns of the user and historical financial behavior patterns of the population of users;
generate computer-learned rules based on the historical financial behavior patterns of the user and the historical financial behavior patterns of the population of users;
generate user-defined rules based on input received from the user, wherein the user-defined rules include one or more of user-defined priorities or user-defined boundaries;
monitor financial behavior of the user in one or more financial accounts;
determine a status change of the user in response to one of a status change indication received from a user device of the user or the monitored financial behavior of the user;
in response to the status change of the user, assume control of the one or more financial accounts, wherein to assume control the one or more processors are configured to perform automated decision-making to manage the one or more financial accounts on behalf of the user;
upon assuming control of the one or more financial accounts, automatically initiate a response to a payment event on behalf of the user, wherein to automatically initiate the response to the payment event on behalf of the user, the one or more processors are configured to:
determine, based on output from the computer-learned rules, a set of responses by the user, wherein the set of likely responses includes one or more likely responses that are similar to actions previously made by the user, and wherein the one or more likely responses are one or more likely payment transactions with the one or more financial accounts in response to the payment event, and
after determining the set of likely responses, compare the set of likely responses to the user-defined rules and select the response from the set of likely responses based on respective similarities, identified by the comparison, of the one or more likely responses included in the set of likely responses to the user-defined rules; and
execute the response to the payment event on behalf of the user.

16. (canceled)

17. (canceled)

18. The computer system of claim 15, wherein the one or more processors are configured to:
receive the status change indication from the user device that includes at least a start date of the status change during which the user plans to be unavailable to control the one or more financial accounts; and
assume control of the one or more financial accounts on the start date.

19. The computer system of claim 15, wherein the one or more processors are configured to:
identify one or more anomalous payment transactions initiated by the user from the monitored financial behavior of the user;
based on a number of the anomalous payment transactions identified within a period of time being greater than a threshold, determine the status change of the user during which the user is deemed to be incapable of controlling the one or more financial accounts; and
assume control of the one or more financial accounts immediately.

20. The computer system of claim 19, wherein, to identify the one or more anomalous payment transactions, the one or more processors are configured to compare the monitored financial behavior of the user to the historical financial behavior patterns of the user.

21. The computer system of claim 15, wherein the one or more processors are configured to, prior to assuming control of the one or more financial accounts, send a notification to the user device indicating the determined status change of the user and that the computer system will assume control of the one or more financial accounts unless the user overrides the determined status change.

22. The computer system of claim 15, wherein to automatically initiate the response to the payment event, the one or more processors are further configured to:
apply the payment event to the computer-learned rules, wherein the computer-learned rules include the at least one machine learning model trained on the historical financial data of the user and the historical financial data of the population of users belonging to the substantially similar demographic as the user.

23. The computer system of claim 15, wherein the one or more processors are configured to:
identify a death of the user;
based on the death of the user, manage the one or more financial accounts according to one or more preferences previously indicated by the user; and
in response to identifying the death of the user, manage one or more social media accounts according to one or more preferences previously indicated by the user.

24. The computer system of claim 15, wherein the one or more processors are configured to:
generate one or more reports on the one or more payment transactions with the one or more financial accounts that are automatically initiated by the computer system on behalf of the user in response to the payment event; and
output the one or more reports to one of the user device of the user or a computing device of another human.

25. A computer-readable medium storing instructions that, when executed, cause one or more processors to:
train at least one machine learning model based on historical financial data of a user and historical financial data of a population of users belonging to a substantially similar demographic as the user;
determine, from the at least one machine learning model, historical financial behavior patterns of the user and historical financial behavior patterns of the population of users;
generate computer-learned rules based on the historical financial behavior patterns of the user and the historical financial behavior patterns of the population of users;
generate user-defined rules based on input received from the user, wherein the user-defined rules include one or more of user-defined priorities or user-defined boundaries;
monitor financial behavior of the user in one or more financial accounts;
determine a status change of the user in response to one of a status change indication received from a user device of the user or the monitored financial behavior of the user;
in response to the status change of the user, assume control of the one or more financial accounts, wherein to assume control the instructions cause the one or more processor to perform automated decision-making to manage the one or more financial accounts on behalf of the user;
upon assuming control of the user's financial accounts, automatically initiate a response to a payment event on behalf of the user, wherein to automatically initiate the response to the payment event on behalf of the user, the instructions cause the one or more processors to:
determine, based on output from the computer-learned rules, a set of likely responses by the user, wherein the set of likely responses includes one or more likely responses that are similar to actions previously made by the user, and wherein the one or more likely responses are one or more likely payment transactions with the one or more financial accounts in response to the payment event, and
after determining the set of likely responses, compare the set of likely responses to the user-defined rules and select the response from the set of likely responses based on respective similarities, identified by the comparison, of the one or more likely responses included in the set of likely responses to the user-defined rules; and
execute the response to the payment event on behalf of the user.

26. The method of claim 1, wherein each computer-learned rule of the computer-learned rules is assigned a first score indicating a likelihood that the computer-learned rule is correct based at least in part on an accuracy of the at least one machine learning model that produced the computer-learned rule, wherein each user-defined rule of the user-defined rules is assigned a second score indicating a level of importance indicated by the user, wherein the set of likely responses by the user are determined based on first scores of the computer-learned rules and wherein the response is selected from the set of likely responses based on second scores of the user-defined rules.

27. The computer system of claim 15, wherein each computer-learned rule of the computer-learned rules is assigned a first score indicating a likelihood that the computer-learned rule is correct based at least in part on an accuracy of the at least one machine learning model that produced the computer-learned rule, wherein each user-defined rule of the user-defined rules is assigned a second score indicating a level of importance indicated by the user, and wherein the one or more processors are configured to:
determine the set of likely responses by the user based on first scores of the computer-learned rules, and
select the response from the set of likely responses based on second scores of the user-defined rules.

28. The method of claim 26,
wherein determining the set of likely responses by the user to the payment event comprises applying a first optimization algorithm to determine the set of likely responses by the user from a subset of the computer-learned rules with first scores that indicate a high likelihood of being correct compared to the other computer-learned rules; and
wherein selecting the response from the set of likely responses comprises applying a second optimization algorithm to select the response from the set of likely responses as the response that has similarity to a user-defined rule with a second score that indicates a high level of importance compared to the other user-defined rules.
